(19) United States
(12) Patent Application Publication
(10) Pub. No.: US 2006/0043750 A1
(43) Pub. Date: Mar. 2, 2006

(54) End-effectors for handling microfeature workpieces

(76) Inventor: Paul Wirth, Columbia Falls, MT (US)

Correspondence Address: PERKINS COIE LLP, P.O. BOX 1247, PATENT-SEA, SEATTLE, WA, 98111-1247, US

(21) Appl. No.: 11/177,937

(22) Filed: Jul. 7, 2005

Related U.S. Application Data
(60) Provisional application No. 60/586,805, filed on Jul. 9, 2004.
(60) Provisional application No. 60/586,514, filed on Jul. 9, 2004.

(51) Int. Cl. B66C 1/42

(52) U.S. Cl. 294/103.1

(57) ABSTRACT

End-effectors and methods for grasping microfeature workpieces are disclosed herein. In one embodiment, an end-effector includes a body, a plurality of passive retaining elements carried by the body, an active retaining assembly movable relative to the body, and an electrical driver operably coupled to the active retaining assembly for moving the assembly. The passive retaining elements define a workpiece-receiving area and the electrical driver selectively moves the active retaining assembly toward the workpiece-receiving area from a retracted position. The active retaining assembly may include one or more rollers for engaging a perimeter edge of the workpiece.

### CROSS-REFERENCE TO RELATED APPLICATION

This application is related to U.S. Patent Application No. ______ (Perkins Coie Docket No. 291958247US), entitled TRANSFER DEVICES AND METHODS FOR HANDLING MICROFEATURE WORKPIECES WITHIN AN ENVIRONMENT OF A PROCESSING MACHINE, filed ______, which is hereby incorporated by reference in its entirety.

### TECHNICAL FIELD

The present invention relates to equipment for handling microfeature workpieces.

### BACKGROUND

Microelectronic devices are fabricated on and/or in microelectronic workpieces using several different apparatus (“tools”). Many such processing apparatus have a single processing station that performs one or more procedures on the workpieces. Other processing apparatus have a plurality of processing stations that perform a series of different procedures on individual workpieces or batches of workpieces. The workpieces are often handled by automatic handling equipment (i.e., robots) because microelectronic fabrication requires very precise positioning of the workpieces and/or conditions that are not suitable for human access (e.g., vacuum environments, high temperatures, chemicals, stringent clean standards, etc.).

An increasingly important category of processing apparatus is plating tools that plate metals and other materials onto workpieces. Existing plating tools use automatic handling equipment to handle the workpieces because the position, movement and cleanliness of the workpieces are important parameters for accurately plating materials onto the workpieces. The plating tools can be used to plate metals and other materials (e.g., ceramics or polymers) in the formation of contacts, interconnects and other components of microelectronic devices. For example, copper plating tools are used to form copper contacts and interconnects on semiconductor wafers, field emission displays, read/write heads and other types of microelectronic workpieces. A typical copper plating process involves depositing a copper seed layer onto the surface of the workpiece using chemical vapor deposition (CVD), physical vapor deposition (PVD), electroless plating processes, or other suitable methods. After forming the seed layer, copper is plated onto the workpiece by applying an appropriate electrical field between the seed layer and an anode in the presence of an electrochemical plating solution. The workpiece is then cleaned, etched and/or annealed in subsequent procedures before transferring the workpiece to another apparatus.

Single-wafer plating tools generally have a load/unload station, a number of plating chambers, a number of cleaning chambers, and a transfer mechanism for moving the workpieces between the various chambers and the load/unload station. The transfer mechanism can be a rotary system having one or more robots that rotate about a fixed location in the plating tool. One existing rotary transfer mechanism is shown in U.S. Pat. No. 6,136,163 issued to Cheung, et al. Alternate transfer mechanisms include linear systems that have an elongated track and a plurality of individual robots that can move independently along the track. Each of the robots on a linear track can also include independently operable end-effectors. Existing linear track systems are shown in: (a) U.S. Pat. Nos. 5,571,325; 6,318,951; 6,752,584; 6,749,390; and 6,322,119; (b) PCT Publication No. WO 00/02808; and (c) U.S. Publication No. 2003/0159921, all of which are herein incorporated in their entirety by reference. Many rotary and linear transfer mechanisms have a plurality of individual robots that can each independently access most, if not all, of the processing stations within an individual tool to increase the flexibility and throughput of the plating tool.

These robots use end-effectors to carry workpieces from one processing station to another. The nature and design of the end-effectors will depend, in part, on the nature of the workpiece being handled. For example, when the backside of the workpiece may directly contact the end-effector, a vacuum-based end-effector may be used. Such vacuum-based end-effectors typically have a plurality of vacuum outlets that draw the backside of the workpiece against a paddle or other type of end-effector. In other circumstances, however, the workpieces have components or materials on both the backside and the device side that cannot be contacted by the end-effector. For example, workpieces that have wafer-level packaging have components on both the device side and the backside. Such workpieces typically must be handled by edge-grip end-effectors, which contact the edge of the workpiece and only a small perimeter portion of the device side and/or backside of the workpiece.

Several current edge-grip end-effectors use an active member that moves in the plane of the workpiece between a release position and a processing position to retain the workpiece on the end-effector. In the release position, the active member is disengaged from the workpiece and spaced apart from the workpiece to allow loading/unloading of the end-effector. In the processing position, the active member presses against the edge of the workpiece to drive the workpiece laterally against other edge-grip members in a manner that secures the workpiece to the end-effector. The active member can be a plunger with a groove that receives the edge of the workpiece, and the other edge-grip members can be projections that also have a groove to receive other portions of the edge of the workpiece. In operation, a pneumatic or hydraulic motor moves the active member radially outward to the release position for receiving a workpiece and then radially inward to the processing position for securely gripping the edge of the workpiece in the grooves of the edge-grip members and the active member.

One concern with both vacuum end-effectors and active edge-grip end-effectors is that they have moving components which are complex and expensive to manufacture and service. For example, these end-effectors include rotary couplings for passing the air and/or hydraulic fluid from the base of the robot to the end-effector. Pneumatic and hydraulic rotary couplings are expensive and require extensive maintenance to prevent leaking and failure. In addition to maintenance expenses, significant downtime may be required to replace or repair the rotary couplings.

Another concern of active edge-grip end-effectors is that the pneumatic or hydraulic motor is difficult to precisely control. More specifically, the pneumatic or hydraulic motor may drive the active member toward the workpiece with inadequate force such that the active member does not properly engage the workpiece or excessive force such that active member strikes the workpiece too hard and damages the workpiece. Accordingly, there is a need to improve end-effectors to increase control and reduce the number of complex and expensive components.

Still another concern of edge-grip end-effectors is accurately determining when a workpiece is securely held in place. Many existing systems use an optical or mechanical flag that provides a signal corresponding to the position of the active member. Although this method is generally suitable, it may give a false positive indication that a workpiece is secured to the end-effector. For example, a workpiece may be askew on the end-effector such that the active member does not engage the workpiece, but a flag system will still indicate that the workpiece is in place if the active member moves to the deployed position. Some systems over extend the active member to avoid this, but the active member may stick and not move to such an over-deployed position. Thus, there is also a need to provide a more accurate indication of workpiece status on the end-effector.

### SUMMARY

The present invention is directed toward end-effectors with electrical components that do not require pneumatic and/or hydraulic power. The end-effectors include an active retaining assembly and an electrical motor or other driver for moving the retaining assembly between a retracted position in which a workpiece is loaded/unloaded and an engagement position in which the workpiece is grasped. Because the end-effectors do not use pneumatic and/or hydraulic power during normal operation, the end-effectors do not have expensive rotary pneumatic couplings and/or rotary hydraulic couplings that may be subject to leaking and failure. The end-effectors accordingly reduce maintenance expenses, reduce system downtime, and increase throughput. Furthermore, the electrical motor or driver provides better control in moving the active retaining assembly to engage a workpiece and sensing whether a workpiece is loaded properly on the end-effector. As such, the end-effectors are expected to properly engage workpieces without striking the workpieces with excessive force.

The end-effectors include a body, a plurality of passive retaining elements carried by the body, an active retaining assembly movable relative to the body, and an electrical driver operably coupled to the active retaining assembly for moving the assembly. The passive retaining elements define a workpiece-receiving area and the electrical driver selectively moves the retaining assembly toward the workpiece-receiving area from a retracted position. The active retaining assembly may include one or more rollers for engaging the perimeter edge of the workpiece. The body can be made of a relatively lightweight material, such as carbon-fiber and vespel, so that a robot can move the end-effector more quickly.

### BRIEF DESCRIPTION OF THE DRAWINGS

FIG. 1 is an isometric view of an apparatus for processing microfeature workpieces including a transfer device for handling the workpieces in accordance with an embodiment of the invention. A portion of the processing apparatus is shown in a cut-away illustration.

FIG. 2A is an isometric view of a transfer device for handling microfeature workpieces in accordance with one embodiment of the invention.

FIG. 2B is an isometric view of a transfer device for handling microfeature workpieces in accordance with another embodiment of the invention.

FIG. 2C is an isometric view of a transfer device for handling microfeature workpieces in accordance with another embodiment of the invention.

FIG. 3 is an isometric view illustrating one embodiment of an end-effector for use on a transfer device.

FIG. 4 is an isometric view of the end-effector of FIG. 3 with a workpiece.

FIG. 5 is a top plan view of a portion of the end-effector of FIG. 3 with a cover removed.

FIG. 6 is a schematic isometric view of a detector in the end-effector for determining the position of an active retaining assembly.

### DETAILED DESCRIPTION

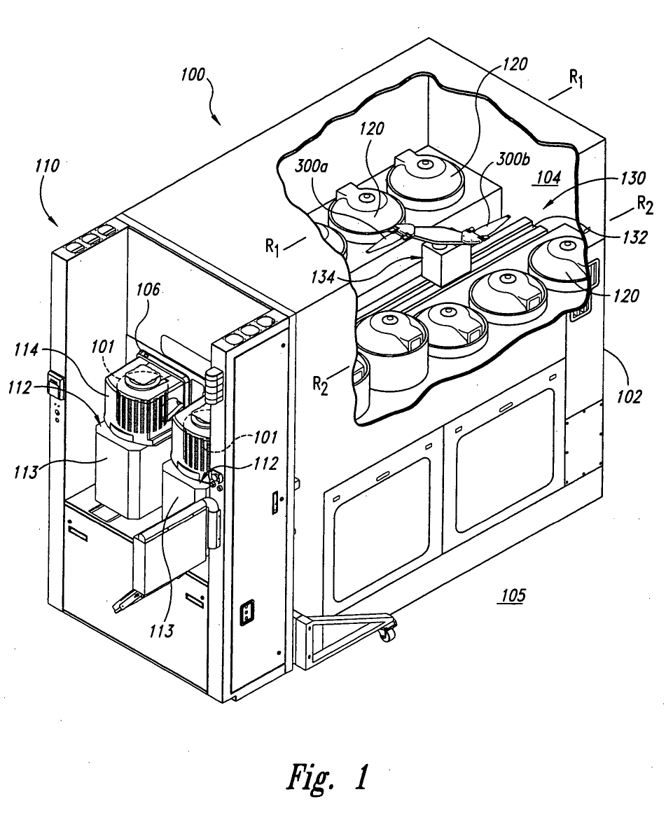

The following description discloses the details and features of several embodiments of end-effectors for handling microfeature workpieces, and methods for using such devices. The terms “microfeature workpiece” or “workpiece” refer to substrates on and/or in which microdevices are formed. Typical microdevices include microelectronic circuits or components, thin-film recording heads, data storage elements, microfluidic devices, and other products. Micromachines or micromechanical devices are included within this definition because they are manufactured in much the same manner as integrated circuits. The substrates can be semiconductive pieces (e.g., silicon wafers or gallium arsenide wafers), nonconductive pieces (e.g., various ceramic substrates), or conductive pieces (e.g., doped wafers). It will be appreciated that several of the details set forth below are provided to describe the following embodiments in a manner sufficient to enable a person skilled in the art to make and use the disclosed embodiments. Several of the details and advantages described below, however, may not be necessary to practice certain embodiments of the invention. Additionally, the invention can also include additional embodiments that are within the scope of the claims, but are not described in detail with respect to FIGS. 1-6.

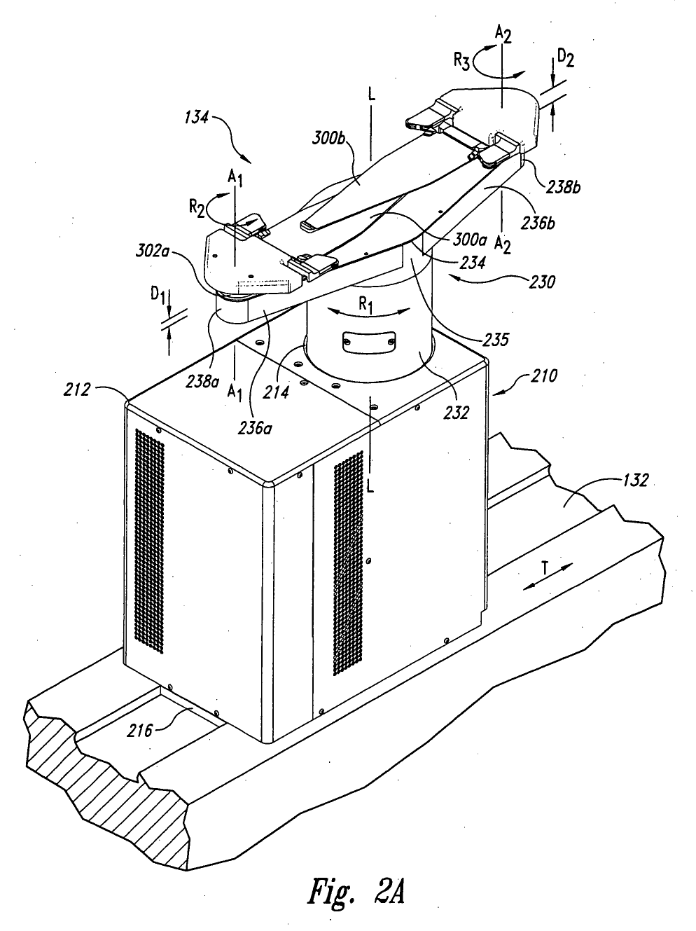

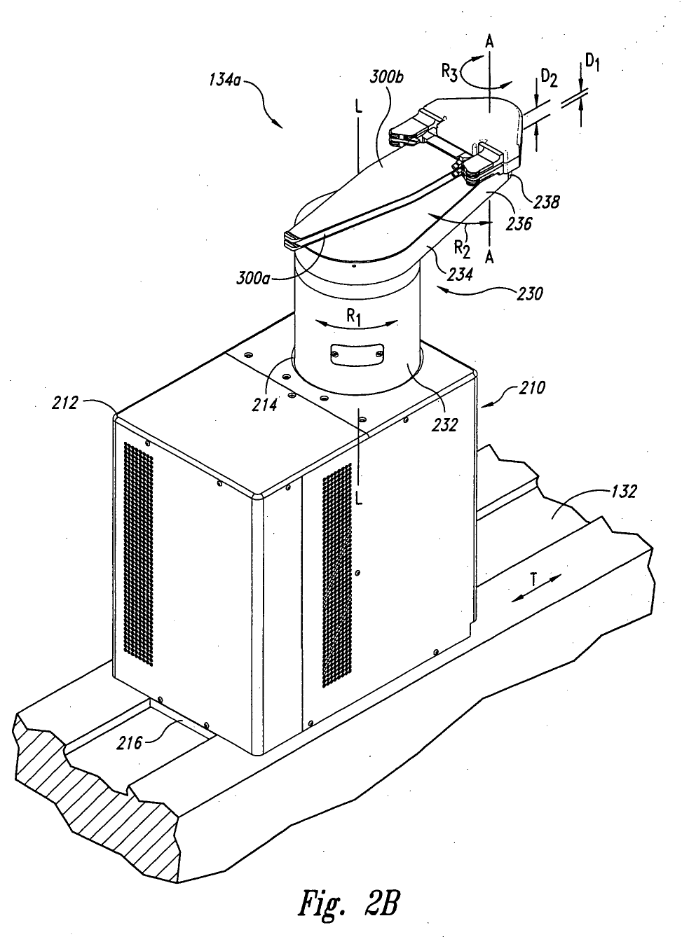

The operation and features of end-effectors for handling microfeature workpieces are best understood in light of the environment and equipment in which they can be used. As such, several embodiments of processing apparatus and transfer devices with which the end-effectors can be used will be described with reference to FIGS. 1-2C. The details and features of several embodiments of end-effectors will then be described with reference to FIGS. 3-6.

A. Embodiments of Microfeature Workpiece Processing Apparatus for Use with Automatic Workpiece Transfer Devices

FIG. 1 is an isometric view of a processing apparatus 100 having a transfer device 130 in accordance with an embodiment of the invention for manipulating a plurality of microfeature workpieces 101. A portion of the processing apparatus 100 is shown in a cut-away view to illustrate selected internal components. The processing apparatus 100 can include a cabinet 102 having an interior region 104 defining an enclosure that is at least partially isolated from an exterior region 105. The illustrated cabinet 102 also includes a plurality of apertures 106 through which the workpieces 101 can ingress and egress between the interior region 104 and a load/unload station 110.

The load/unload station 110 can have two container supports 112 that are each housed in a protective shroud 113. The container supports 112 are configured to position workpiece containers 114 relative to the apertures 106 in the cabinet 102. The workpiece containers 114 can each house a plurality of microfeature workpieces 101 in a “mini” clean environment for carrying a plurality of workpieces through other environments that are not at clean room standards. Each of the workpiece containers 114 is accessible from the interior region 104 of the cabinet 102 through the apertures 106.

The processing apparatus 100 further includes a plurality of processing stations 120 and the transfer device 130 in the interior region 104 of the cabinet 102. The processing apparatus 100, for example, can be a plating tool, and the processing stations 120 can be single-wafer chambers for electroplating, electroless plating, annealing, cleaning, etching, and/or metrology analysis. Suitable processing stations 120 for use in the processing apparatus 100 are disclosed in U.S. Pat. Nos. 6,660,137; 6,569,297; 6,471,913; 6,309,524; 6,309,520; 6,303,010; 6,280,583; 6,228,232; and 6,080,691, and in U.S. patent application Ser. Nos. 10/861,899; 10/729,349; and 09/733,608, all of which are herein incorporated in their entirety by reference. The processing stations 120 are not limited to plating devices, and thus the processing apparatus 100 can be another type of tool.

The transfer device 130 moves the microfeature workpieces 101 between the workpiece containers 114 and the processing stations 120. For example, the transfer device 130 can include a linear track 132 extending in a lengthwise direction of the interior region 104 between the processing stations 120. In the embodiment shown in FIG. 1, a first set of processing stations 120 is arranged along a first row R₁-R₁ and a second set of processing stations 120 is arranged along a second row R₂-R₂. The linear track 132 extends between the first and second rows R₁-R₁ and R₂-R₂ of the processing stations 120. The transfer device 130 can further include a robot unit 134 carried by the track 132.

B. Embodiments of Transfer Devices for Handling Microfeature Workpieces in Processing Machines

FIG. 2A illustrates an embodiment of the robot unit 134 in greater detail. The robot unit 134 can include a transport unit 210, an arm assembly 230 carried by the transport unit 210, and first and second end-effectors 300 (identified individually as 300a and 300b) carried by the arm assembly 230. The transport unit 210 can include a shroud or housing 212 having a plurality of panels attached to an internal frame (not shown in FIG. 2A). An opening 214 in a top panel of the housing 212 receives a portion of the arm assembly 230. It will be appreciated that the transport unit 210 and the housing 212 can have many different configurations depending upon the particular environment in which the robot unit 134 is used. The transport unit 210, for example, can include a base that is stationary, rotary, or moves in a nonlinear manner. The transport unit 210 can also include a guide member configured to move laterally along the track 132. The particular embodiment of the transport unit 210 shown in FIG. 2A includes a guide member defined by a base plate 216 that slidably couples the robot unit 134 to the track 132. The robot unit 134 can accordingly translate along the track 132 (arrow T) to position the robot unit 134 adjacent to a desired processing station 120 (FIG. 1).

The arm assembly 230 can include a waist member 232 that is coupled to a lift assembly (not shown in FIG. 2A). The arm assembly 230 can also include an arm 234 having a medial section 235, a first extension 236a projecting from one side of the medial section 235, and a second extension 236b projecting from another side of the medial section 235. The first and second extensions 236a-b of the arm 234 can be diametrically opposed to one another as shown in FIG. 2A, or they can extend at a desired angle relative to each other. In one embodiment, the first and second extensions 236a-b are integral with each other, but in alternate embodiments the first and second extensions 236a-b can be individual components that are fixed to each other. The first and second extensions 236a-b have a fixed length and are fixedly attached to the waist member 232 so that they rotate with the waist member 232. As such, the first and second extensions 236a-b define a single link arm to which the end-effectors 300 can be attached directly without intervening links pivotally attached between the extensions 236a-b and the end-effectors 300.

The arm assembly 230 can move along a lift path L-L to change the elevation of the arm 234 for positioning the end-effectors 300 at desired elevations. The lift path L-L generally extends transverse to the track 132, which as used herein includes any oblique or perpendicular arrangement. The arm assembly 230 can also rotate (arrow R₁) about the lift path L-L to position a distal end 238a of the first extension 236a and/or a distal end 238b of the second extension 236b proximate to a desired workpiece container 114 (FIG. 1) or processing station 120 (FIG. 1). The first and second extensions 236a-b generally rotate about the lift path L-L as a single unit because they are integral or fixed with each other. The motion of the first and second extensions 236a-b are accordingly dependent upon each other in this embodiment. In alternate embodiments, the arm 234 can have extensions that are not fixed to each other and can move independently from each other, or the arm assembly 230 may be at a fixed elevation.

The end-effectors 300 are rotatably carried by the arm 234. For example, in the embodiment illustrated in FIG. 2A, the first end-effector 300a is rotatably coupled to the first distal end 238a of the arm 234 to pivot about a first rotation axis A₁-A₁ (arrow R₂), and the second end-effector 300b is rotatably coupled to the second distal end 238b of the arm 234 to pivot about a second rotation axis A₂-A₂ (arrow R₃). The first and second rotation axes A₁-A₁ and A₂-A₂ can be generally parallel to the lift path L-L, but in alternate embodiments these axes can extend transverse to the lift path L-L. The rotational motion of (a) the arm 234 about the lift path L-L, (b) the first end-effector 300a about the first rotation axis A₁-A₁, and (c) the second end-effector 300b about the second rotation axis A₂-A₂ can be coordinated so that the first and second end-effectors 300a-b are each positioned adjacent to any of the workpiece containers 114 (FIG. 1) and processing stations 120 (FIG. 1) on either side of the cabinet 102 (FIG. 1).

The first end-effector 300a can be spaced apart from the arm 234 by a first distance D₁, and the second end-effector 300b can be spaced apart from the arm 234 by a second distance D₂. In the embodiment shown in FIG. 2A, the distance D₁ is less than the distance D₂ such that the first end-effector 300a is at a different elevation than the second end-effector 300b. The first end-effector 300a accordingly moves through a first plane as it rotates about the first rotation axis A₁-A₁, and the second end-effector 300b moves through a second plane as it rotates about the second rotation axis A₂-A₂. The first and second planes are generally parallel and fixedly spaced apart from each other so that the end-effectors 300 cannot interfere with each other. The first and second planes, however, can have other arrangements (i.e., nonparallel) so long as they do not intersect in a region over the arm 234. The first and second end-effectors 300a-b can be fixed at the particular elevations relative to the arm 234 using spacers or other types of devices. For example, the first end-effector 300a can be spaced apart from the arm 234 by a first spacer 302a, and the second end-effector 300b can be spaced apart from the arm 234 by a second spacer (not shown). The first and second spacers 302a-b can have different thicknesses to space the end-effectors 300 apart from the arm 234 by the desired distances.

The first and second end-effectors 300a-b and the arm 234 can have different configurations than the configuration shown in FIG. 2A. For example, FIG. 2B is an isometric view illustrating another embodiment of a robot unit 134a. The robot unit 134a is generally similar to the robot unit 134 described above with reference to FIG. 2A. In the illustrated robot unit 134a, however, the arm 234 has only a single extension 236 projecting from the waist member 232 and the first and second end-effectors 300a-b are carried by the “single-extension” arm 234 such that the end-effectors 300 are fixed at different elevations relative to the arm 234. The first and second end-effectors 300a-b, for example, can be coupled to the distal end 238 of the arm 234 and rotate about a common rotation axis A-A.

FIG. 2C is an isometric view illustrating another embodiment of a robot unit 134b. The robot unit 134b is generally similar to the robot units 134 and 134a described above with reference to FIGS. 2A and 2B. The illustrated robot unit 134b, however, includes only a single end-effector 300 attached to the distal end 238 of the arm 234.

C. Embodiments of End-Effectors for Handling Microfeature Workpieces

FIG. 3 is an isometric view illustrating one embodiment of the end-effector 300. The illustrated end-effector 300 includes a body 310, a plurality of passive retaining elements 320 (identified individually as 320a-c) on the body 310, and an active retaining assembly 340 movable relative to the body 310. The body 310 supports a microfeature workpiece, and the passive retaining elements 320 and the active retaining assembly 340 work together to secure the workpiece to the body 310 while the robot unit 134 (FIG. 2A) moves the workpiece. As such, the passive retaining elements 320 and the active retaining assembly 340 prevent the end-effector 300 from dropping the workpiece during transport.

The body 310 is typically a planar member having a fork, paddle, or other suitable configuration for carrying the workpiece. The illustrated body 310 includes a proximal portion 312 having a first width W₁, a distal portion 314 having a second width W₂ less than the first width W₁, and an intermediate portion 316 between the proximal and distal portions 312 and 314. The intermediate portion 316 can be a solid section without apertures, or alternatively, the intermediate portion 316 can have holes or slots to mitigate backside contamination of the workpiece. The body 310 is made of a stiff material that is dimensionally stable so that the robot unit 134 (FIG. 2A) can accurately pick up and place workpieces. The material may also be relatively lightweight to (a) reduce the force required for the robot unit 134 to move the end-effector 300 and (b) allow the robot unit 134 to move the end-effector 300 more quickly. Suitable materials include carbon-fiber and vespel materials manufactured by DuPont. In several embodiments, the body 310 can be made of different materials and/or have other configurations.

The passive retaining elements 320 are arranged on the body 310 along a circle S corresponding to a diameter of the workpiece. In the illustrated embodiment, first and second passive retaining elements 320a-b are attached at the proximal portion 312 of the body 310, and a third passive retaining element 320c is attached at the distal portion 314 of the body 310. The three-point element configuration of the end-effector 300 shown in FIG. 3 provides a base for supporting the workpiece during transport. It will be appreciated that the body 310 can have a different number and/or arrangement of passive retaining elements 320 in other applications.

The passive retaining elements 320a-c have generally similar structures for supporting the workpiece. More specifically, the individual passive retaining elements 320a-c include a support surface 324 for carrying a perimeter portion of the workpiece and an edge stop 326 projecting upwardly from the support surface 324. The edge stops 326 circumscribe a circle that has a diameter slightly greater than the diameter of the workpiece to limit lateral movement of the workpiece within the circle S. The edge stops 326 can have a contact surface 328 for pressing radially inwardly against a perimeter edge of the workpiece. At least a portion of the contact surface 328 of the passive retaining elements 320 can slope upwardly inwardly toward the workpiece to inhibit the workpiece from moving upwardly and over the retaining elements 320. The passive retaining elements 320a-c can also have an inclined surface 322 sloping downwardly from the support surface 324. The passive retaining elements 320a-c can accordingly support an outer edge of the workpiece such that the workpiece is held in a plane spaced apart from the body 310 to minimize contamination of the workpiece. It will be appreciated that the passive retaining elements 320 can have other configurations for supporting the workpiece.

The illustrated active retaining assembly 340 includes a yoke 342 and a plurality of rollers 350 (identified individually as 350a-d) coupled to the yoke 342. The yoke 342 includes a first end portion 344a carrying first and second rollers 350a-b and a second end portion 344b carrying third and fourth rollers 350c-d. The rollers 350 can include a groove 352 for selectively engaging a perimeter edge of the workpiece. The active retaining assembly 340 is movable between a retracted position for loading/unloading a workpiece and an engagement position for grasping the workpiece. More specifically, the active retaining assembly 340 moves in a direction F from the retracted position to the engagement position in which the rollers 350 engage the perimeter edge of the workpiece. When the active retaining assembly 340 is in the engagement position, the end-effector 300 securely holds the workpiece between the rollers 350 and the third passive retaining element 320c. To unload the workpiece, the active retaining assembly 340 moves in a direction B from the engagement position to the retracted position in which the rollers 350 are disengaged from the workpiece. In several embodiments, the active retaining assembly 340 can include a different number of rollers 350, or alternatively, a different type of active retaining member(s) coupled to the yoke 342 in addition to or in lieu of the rollers 350.

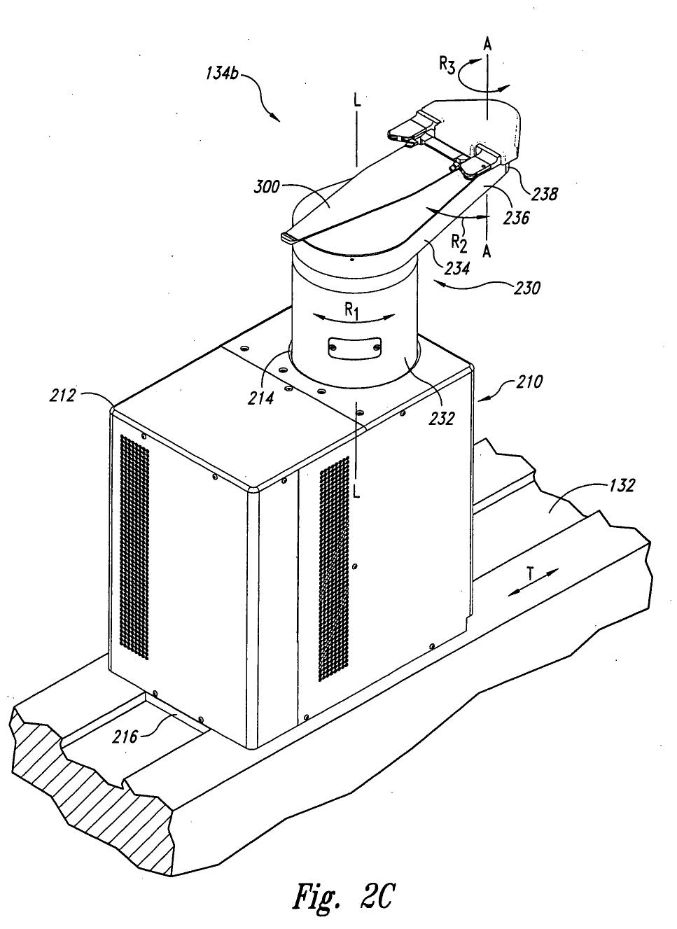

FIG. 4 is an isometric view of the end-effector 300 with a workpiece W for illustrating one purpose of the rollers 350 in greater detail. As the active retaining assembly 340 moves in the direction F to engage the perimeter edge of the workpiece W, the rollers 350 center the workpiece W as it is clamped between the third passive retaining element 320c and the rollers 350. For example, if the workpiece W is skewed relative to the body 310, the workpiece W will move along the rollers 350 as the yoke 342 moves in the direction F. The rotation of the rollers 350 accordingly centers the workpiece W relative to the body 310. Moreover, by having two rollers 350 in a stepped or angled arrangement on each side of the yoke 342, the rollers 350 cause the workpiece W to move relative to the body 310 even when an alignment notch N is positioned at one of the rollers 350.

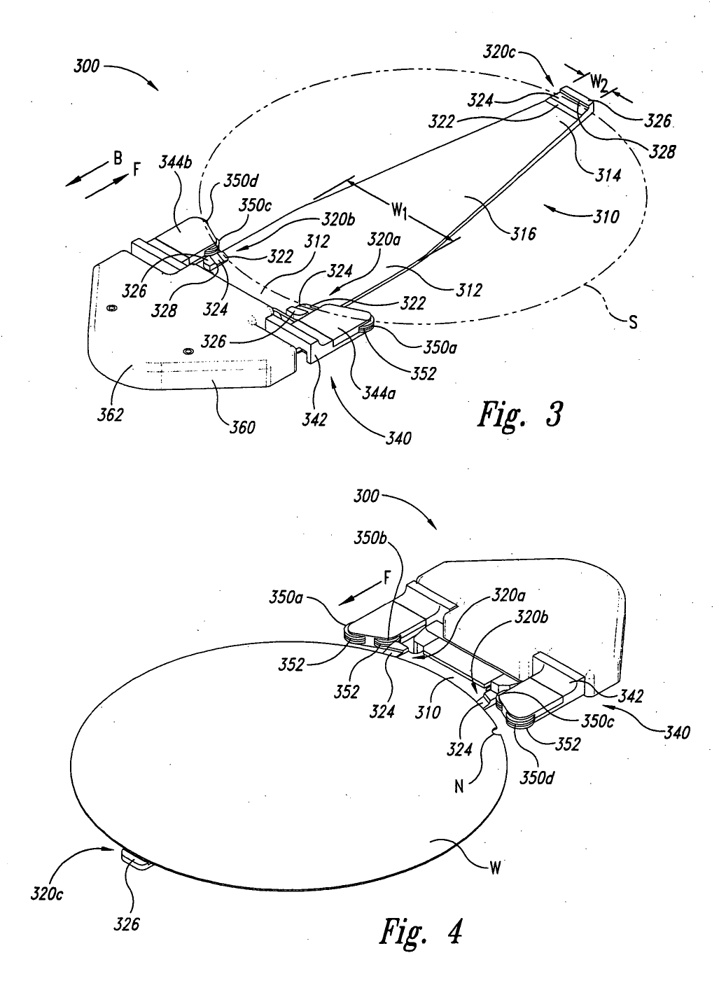

FIG. 5 is a top plan view of a portion of the end-effector 300 of FIG. 3 with a cover 362 (shown in FIG. 3) removed. The illustrated end-effector 300 further includes (a) an electrical driver 370 for moving the active retaining assembly 340 between the retracted and engagement positions, (b) an actuator 375 operably coupled to the electrical driver 370 and the active retaining assembly 340 for transmitting motion from the driver 370 to the assembly 340, and (c) a base 378 coupled to the body 310 for carrying the electrical driver 370. As such, the electrical driver 370 moves the actuator 375, which in turn drives the active retaining assembly 340. The electrical driver 370 can be a stepper motor, a DC motor, a piezoelectric motor, a linear motor, a solenoid, or another suitable device for moving the active retaining assembly 340 between the retracted and engagement positions. The actuator 375 can be a rotating or translating shaft or other suitable device for transmitting motion from the electrical driver 370 to the active retaining assembly 340. In the illustrated embodiment, for example, the actuator 375 includes a leadscrew and the yoke 342 includes a nut 348 with a threaded hole. The threads on the leadscrew engage the threads in the nut 348 so that rotation of the leadscrew moves the yoke 342 linearly in a direction parallel to the leadscrew. As such, the leadscrew drives the active retaining assembly 340 in the direction B or F depending upon the direction of rotation. In other embodiments, the actuator 375 can have a different configuration for transferring motion from the electrical driver 370 to the active retaining assembly 340. Moreover, in several embodiments, the base 378 can include one or more guides 365 and the yoke 342 can include corresponding channels 346 that slidably receive the guides 365 for restricting transverse movement of the active retaining assembly 340.

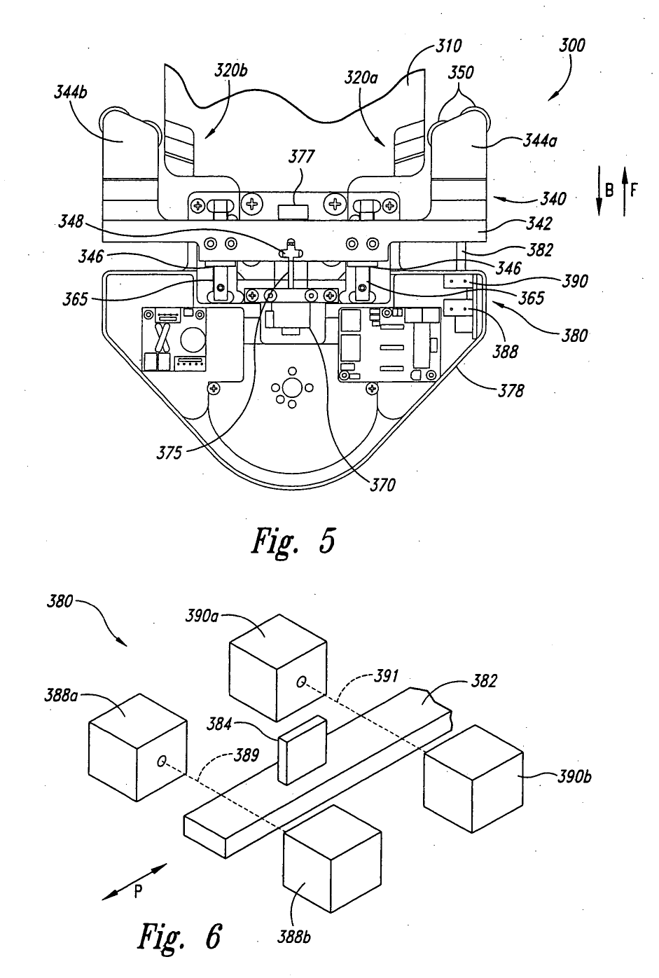

The illustrated end-effector 300 further includes a detector 380 for determining the position of the active retaining assembly 340 relative to the base 378. The illustrated detector 380 includes a shaft 382 coupled to the yoke 342 and first and second flag sensors 388 and 390 carried by the base 378. The shaft 382 includes a flag (shown in FIG. 6) and the first and second flag sensors 388 and 390 are positioned along a path of travel of the flag to detect the position of the flag. Based on the position of the flag, the detector 380 can determine the position of the active retaining assembly 340 as the assembly 340 moves between the retracted and engagement positions.

FIG. 6 is a schematic isometric view of the detector 380 in greater detail. In the illustrated embodiment, the flag 384 moves in a straight path P, and the first and second flag sensors 388 and 390 are horizontally spaced apart from one another. The first and second flag sensors 388 and 390 are configured to detect the presence or proximity of the flag 384 at a particular location in the travel path P. The first and second flag sensors 388 and 390 may detect the flag 384 in a variety of fashions. For example, the flag 384 may carry a magnet (not shown) and the first and second flag sensors 388 and 390 may be responsive to the proximity of the magnet in the flag 384.

In the illustrated embodiment, however, the first flag sensor 388 includes a first light source 388a and a first light sensor 388b, which are positioned on opposite sides of the travel path P of the flag 384. Similarly, the second flag sensor 390 includes a second light source 390a and a second light sensor 390b, which are positioned on opposite sides of the travel path P. The flag 384 is desirably opaque to wavelengths of light emitted by the first and second light sources 388a and 390a. When the opaque flag 384 is positioned between the first light source 388a and the first light sensor 388b, the flag 384 interrupts a beam of light 389 passing from the first light source 388a to the first light sensor 388b. This may generate a first flag position signal indicating that, for example, the active retaining assembly 340 (FIG. 5) is in the retracted position. Similarly, if the opaque flag 384 is positioned between the second light source 390a and the second light sensor 390b, the flag 384 will interrupt a beam of light 391 passing from the second light source 390a to the second light sensor 390b. This may generate a second flag position signal indicating that, for example, the active retaining assembly 340 is in the engagement position.

Referring back to FIG. 5, in other embodiments, the end-effector 300 may include other detectors for determining the position of the active retaining assembly 340. For example, the detector may be an encoder operably coupled to the electrical driver 370 to determine the position of the active retaining assembly 340 based on the output of the electrical driver 370. For example, in embodiments in which the electrical driver 370 is a stepper motor and the actuator 375 is a leadscrew, the encoder can determine the position of the active retaining assembly 340 based on the number of rotations of the leadscrew. In several embodiments, the end-effector 300 can determine the position of the active retaining assembly 340 with a timer based on a known speed of the retaining assembly 340. Alternatively, the end-effector 300 may not include a detector, but rather the electrical driver 370 may move the retaining assembly 340 to a hard stop.

The illustrated end-effector 300 further includes a workpiece pressure sensor 377 (shown schematically) coupled to the yoke 342 for determining the presence of a workpiece on the body 310. The workpiece pressure sensor 377 can include a switch, which is tripped when a workpiece is placed on the body 310. For example, the sensor 377 may include a spring-loaded plunger with a magnet and a member that is responsive to the proximity of the magnet. When a workpiece is loaded onto the body 310 and the active retaining assembly 340 moves to the engagement position, the workpiece contacts the plunger and moves the plunger from a first position to a second position. The member detects the change in the position of the magnet and, consequently, the presence of a workpiece on the body 310. In other embodiments, the workpiece pressure sensor can have other configurations and/or be positioned at different locations on the end-effector. In any of these embodiments, the pressure sensor can determine not only the presence of the workpiece but also if the workpiece is properly seated on the passive retaining elements 320.

One feature of the illustrated end-effector 300 is that the driver 370, the workpiece sensor 377, and the detector 380 are all electrically powered. As such, the end-effector 300 requires only rotary electrical couplings between the end-effector 300 and the arm 234 (FIG. 2A), which reduces the number of required rotary couplings. In contrast, conventional end-effectors include rotary electrical couplings and rotary hydraulic and/or pneumatic couplings. Rotary hydraulic and pneumatic couplings are expensive and require extensive maintenance to prevent leaking and failure of the moving parts. Accordingly, the end-effector 300 illustrated in FIG. 3 (a) reduces maintenance expenses, (b) reduces the downtime to replace or repair components, and (c) increases throughput.

Another feature of the illustrated end-effector 300 is that the electrical driver 370 provides precise control over the movement of the active retaining assembly 340. An advantage of this feature is that the active retaining assembly 340 is expected to properly engage workpieces on a consistent basis without striking the workpieces with excessive force and damaging the workpieces. For example, in several embodiments, an encoder can slow the movement of the active retaining assembly just before the assembly contacts the workpiece so that the assembly engages the workpiece without excessive force. Moreover, the encoder can be coupled to the pressure sensor to determine whether a workpiece is properly seated on the body 310. For example, after the encoder has moved the active retaining assembly to the engagement position, if the pressure sensor has not sensed the presence of the workpiece, the encoder may generate a signal indicating that the workpiece is not properly seated on the end-effector.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. An end-effector for handling a microfeature workpiece having a perimeter edge, the end-effector comprising:
a body;
a plurality of passive retaining elements carried by the body, the passive retaining elements defining a workpiece-receiving area;
an active retaining assembly movable relative to the body, the active retaining assembly including a roller for engaging the perimeter edge of the microfeature workpiece; and
an electrical driver operably coupled to the active retaining assembly for moving the assembly toward the workpiece-receiving area from a retracted position.

2. The end-effector of claim 1 wherein the roller is a first roller, wherein the active retaining assembly further includes a second roller and a yoke, and wherein the yoke includes a first end portion carrying the first roller and a second end portion carrying the second roller.

3. The end-effector of claim 1 wherein the end-effector operates without a rotary pneumatic coupling.

4. The end-effector of claim 1 wherein the end-effector operates without a rotary hydraulic coupling.

5. The end-effector of claim 1 wherein the end-effector operates normally without hydraulic and/or pneumatic power.

6. The end-effector of claim 1 wherein the body comprises a carbon-fiber and vespel material.

7. The end-effector of claim 1 wherein the body includes a distal portion and a proximal portion, and wherein at least one passive retaining element is positioned on the proximal portion.

8. The end-effector of claim 1, further comprising a position sensor for determining the position of the active retaining assembly.

9. The end-effector of claim 1, further comprising an encoder operably coupled to the electrical driver for determining the position of the active retaining assembly.

10. The end-effector of claim 1, further comprising a workpiece pressure sensor for detecting when a workpiece is carried by the end-effector.

11. The end-effector of claim 1, further comprising a shaft operably coupled to the electrical driver and the active retaining assembly for transmitting motion from the electrical driver to the retaining assembly.

12. The end-effector of claim 1, further comprising a leadscrew operably coupled to the electrical driver and the retaining assembly;
wherein the electrical driver comprises an electrical motor for rotating the leadscrew; and
wherein the retaining assembly further comprises a threaded hole sized and configured to receive a portion of the leadscrew so that rotation of the leadscrew moves the retaining assembly linearly.

13. The end-effector of claim 1 wherein the electrical driver comprises a stepper motor.

14. The end-effector of claim 1 wherein the electrical driver comprises a DC motor.

15. The end-effector of claim 1 wherein the electrical driver comprises a linear motor.

16. The end-effector of claim 1 wherein the electrical driver comprises a piezoelectric motor.

17. The end-effector of claim 1 wherein the electrical driver comprises a solenoid.

18. The end-effector of claim 1 wherein the body includes a proximal end portion, a distal end portion, and an intermediate portion between the proximal and distal end portions, and wherein the intermediate portion is a solid section without apertures.

19. The end-effector of claim 1 wherein the body includes a proximal portion having a first width and a distal portion have a second width less than the first width.

20. An end-effector for handling a microfeature workpiece, the end-effector comprising:
a body having a proximal portion and a distal portion opposite the proximal portion;
a first passive retaining element carried by the proximal portion of the body;
a second passive retaining element carried by the distal portion of the body;
an active retaining assembly configured to selectively engage the microfeature workpiece when the body carries the workpiece; and
an electrical driver operably coupled to the active retaining assembly for moving the assembly relative to the body between a retracted position and an engagement position;
wherein the end-effector operates without a rotary pneumatic coupling.

21. The end-effector of claim 20 wherein the active retaining assembly includes a yoke and first and second rollers coupled to the yoke, and wherein the first and second rollers are configured to engage a perimeter edge of the workpiece.

22. The end-effector of claim 20 wherein the end-effector operates normally without pneumatic power.

23. The end-effector of claim 20 wherein the body comprises a carbon-fiber and vespel material.

24. The end-effector of claim 20 wherein the electrical driver comprises a stepper motor.

25. An end-effector for handling a microfeature workpiece having a perimeter edge, the end-effector comprising:
a body having a proximal portion and a distal portion opposite the proximal portion;
a plurality of spaced-apart, stationary retaining elements carried by the body, the stationary retaining elements configured to support the workpiece in a plane spaced apart from the body, the stationary retaining elements including at least one retaining element positioned at the proximal portion of the body;
an active retaining assembly movable relative to the body, the active retaining assembly including a yoke with a first portion and a second portion opposite the first portion, the active retaining assembly further including a first roller coupled to the first portion and a second roller coupled to the second portion;
an actuator operably coupled to the active retaining assembly for moving the assembly between a retracted position to load/unload the workpiece and an engagement position to hold the workpiece;
an electrical motor for driving the actuator to move the active retaining assembly; and
a position sensor for determining the position of the active retaining assembly.

26. The end-effector of claim 25 wherein the actuator comprises a shaft operably coupled to the electrical motor, and wherein the electrical motor is configured to rotate the shaft.

27. The end-effector of claim 25 wherein:
the actuator comprises a leadscrew operably coupled to the electrical motor and the active retaining assembly;
the electrical motor is configured to rotate the leadscrew; and
the active retaining assembly further comprises a threaded hole sized and configured to receive a portion of the leadscrew so that rotation of the leadscrew moves the retaining assembly linearly.

28. The end-effector of claim 25 wherein the electrical motor comprises a stepper motor.

29. The end-effector of claim 25 wherein the end-effector operates without a rotary pneumatic coupling.

30. The end-effector of claim 25 wherein the end-effector operates normally without pneumatic power.

31. An end-effector for handling a microfeature workpiece, the end-effector comprising:
a body comprising a carbon-fiber and vespel material;
a passive retaining element carried by the body;
an active retaining assembly movable relative to the body, the passive retaining element and the active retaining assembly configured to selectively grasp the workpiece; and
a driver operably coupled to the active retaining assembly for moving the assembly between a retracted position and an engagement position.

32. The end-effector of claim 31 wherein the driver comprises an electrical motor.

33. The end-effector of claim 31 wherein the end-effector operates without a rotary pneumatic coupling.

34. The end-effector of claim 31 wherein the end-effector operates normally without pneumatic power.

35. The end-effector of claim 31 wherein the active retaining assembly comprises a yoke and first and second rollers coupled to the yoke, and wherein the first and second rollers are configured to engage a perimeter edge of the workpiece.

36. A transfer device for handling a microfeature workpiece, the transfer device comprising:
a transport unit configured to move along a transport path;
a lift assembly carried by the transport unit;
an arm carried by the lift assembly; and
an end-effector rotatably coupled to the arm, the end-effector comprising a body, a plurality of passive retaining elements carried by the body, an active retaining assembly for engaging a perimeter edge of the workpiece, and an electrical means for moving the active retaining assembly between a retracted position and an engagement position, wherein the body includes a proximal portion and at least one of the passive retaining elements is positioned at the proximal portion of the body.

37. The transfer device of claim 36 wherein the electrical means for moving the active retaining assembly comprises a stepper motor.

38. The transfer device of claim 36 wherein the end-effector is coupled to the arm without a rotary pneumatic coupling.

39. The transfer device of claim 36 wherein the end-effector operates normally without pneumatic power.

40. A method of grasping a microfeature workpiece, comprising:
providing an end-effector having a body, a plurality of passive retaining elements carried by the body, an active retaining assembly movable relative to the body, and an electrical driver operably coupled to the active retaining assembly, wherein the body includes a proximal portion and at least one of the passive retaining elements is disposed on the proximal portion;
positioning a microfeature workpiece on the passive retaining elements; and
energizing the electrical driver to move the active retaining assembly from a retracted position to an engagement position for holding the workpiece.

41. The method of claim 40 wherein energizing the electrical driver comprises providing electrical power to a stepper motor for driving the active retaining assembly from the retracted position to the engagement position.

42. The method of claim 40 wherein energizing the electrical driver comprises engaging first and second rollers with a perimeter edge of the workpiece when the active retaining assembly is in the engagement position.

43. The method of claim 40 wherein energizing the electrical driver comprises securing the workpiece to the end-effector without pneumatic power.

44. The method of claim 40 wherein providing the end-effector comprises providing an arm rotatably coupled to the end-effector without a rotary pneumatic coupling, and wherein the method further comprises moving the end-effector relative to the arm.

45. The method of claim 40 wherein energizing the electrical driver comprises:
rotating a leadscrew with the electrical driver; and
driving the active retaining assembly along a linear path with the rotating leadscrew.

46. A method of grasping a microfeature workpiece, comprising:
placing a microfeature workpiece on a plurality of passive retaining elements of an end-effector;
driving first and second rollers toward the microfeature workpiece with an electrical motor; and
engaging the workpiece with the first and second rollers.
